(19) United States
(12) Patent Application Publication
(10) Pub. No.: US 2026/0140041 A1
(43) Pub. Date: May 21, 2026

(54) Optico-dynamic Light Tunnel

(71) Applicant: Srinivas Dutt, Brooksville, FL (US)

(72) Inventor: Srinivas Dutt, Brooksville, FL (US)

(21) Appl. No.: 18/951,597

(22) Filed: Nov. 18, 2024

(51) Int. Cl. G01N 21/01; G01N 21/17; G01N 21/19; G01N 21/41

(52) U.S. Cl. CPC G01N 21/01; G01N 21/19; G01N 21/4133; G01N 2021/0112; G01N 2021/1765; G01N 2021/1785; G01N 2021/416

(57) ABSTRACT

An Optico-dynamic Light Tunnel is provided. This apparatus provides visual assessment of the entire pathway of a lens field. This apparatus may include linear strands of light that can be created and their propagation pathways visualized. This apparatus may stratify light strands to create an optical tunnel. This apparatus may apply this optical tunnel to lens objects to dynamically analyze optical properties over the entire lens field pathway and in multiple dimensions.

### CROSS-REFERENCE TO RELATED APPLICATIONS

This application claims the benefit of priority of U.S. provisional application No. 63/600,715, filed Nov. 19, 2023, the contents of which are herein incorporated by reference.

### STATEMENT REGARDING FEDERALLY SPONSORED RESEARCH OR DEVELOPMENT: N/A

### THE NAMES OF THE PARTIES TO A JOINT RESEARCH AGREEMENT: N/A

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM: N/A

### STATEMENT REGARDING PRIOR DISCLOSURES BY THE INVENTOR OR A JOINT INVENTOR: N/A

### BACKGROUND OF THE INVENTION

### Field of the Invention

Class 359: OPTICS: SYSTEMS (INCLUDING COMMUNICATION) AND ELEMENTS

### Description of Related Art

The present invention relates to a direct visualization of light propagation through a total lens field. Lenses modify light and these effects on light are used for various purposes. Multiple lens designs have been developed to utilize these effects including spectacles, telescopes, contact lenses, and intraocular lenses. Correspondingly, many techniques have been used to precisely measure and quantify these effects. Optical metrology involves assessing lens resolution, contrast, distortion, depth of field, illumination, refractive power, and aberrations. Commonly used tests include modulation transfer function, reverse projection, point spread function, and camera tests using various test targets. These modalities provide indirect descriptions of optical behavior and primarily evaluate the end result of the optical effects. There has not been an emphasis on visually and directly observing light behavior as it propagates through a complete lens field involving light pathways anterior and posterior and inside a lens object. This misses key data about the optical characteristics of a lens.

As can be seen, there is a need for improved optical analysis of a lens object using direct visualization. The present invention provides a novel method of detailed visual imaging of total light pathways in an optical field. This apparatus creates direct visualization of the pre-lenticular, intra-lenticular, and post-lenticular space of a lens field in real time. This invention by uniquely providing direct visualization of the optical behavior of a lens, delivers new data for improvements in lens design.

### BRIEF SUMMARY OF THE INVENTION

In one aspect of the present invention, this apparatus allows direct visualization of the optical properties of a lens. Discrete, linear visible strands of light can be stratified into an array, creating a light tunnel and utilized to visually map light propagation through a lens field. The pathways through the entire lens field anterior to the lens, in the lens, and posterior to the lens can be visualized. Introducing changes and monitoring in real time for effects allows a dynamic visual analysis of the optical properties of a lens in multiple dimensions. These and other features, aspects, and advantages of the present invention will become better understood with reference to the following drawing, descriptions, and claims.

### BRIEF DESCRIPTION OF THE VIEW OF THE DRAWING

FIG. 1 is a perspective of the present invention illustrating the apparatus which involves a visualization chamber containing light detecting media and includes a light source, lens object, and a photodetector. Discrete stratified linear light strands are visualized as they propagate through a complete lens field.

### DETAILED DESCRIPTION OF THE INVENTION.

The following is a detailed description of the best currently contemplated modes of carrying out exemplary embodiments of the invention. The description is not to be taken in a limiting sense, but is made merely for the purpose of illustrating the general principles of the invention.

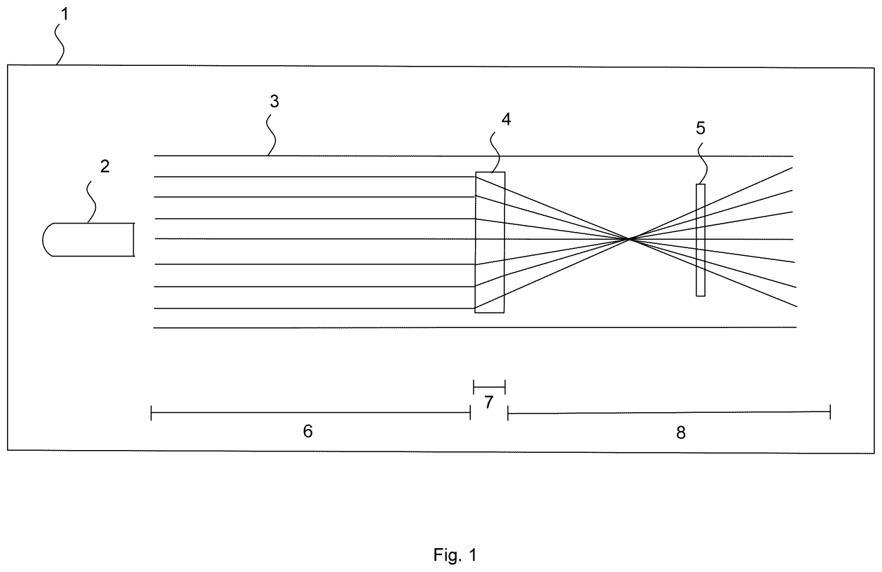

The present apparatus to visualize light pathways through a total lens field is described. As referenced in FIG. 1, it includes a visualization chamber 1 which contains the light source 2, lens object 4, and a photodetector 5. It contains the lens field that encompasses the pre-lenticular space 6, intra-lenticular space 7 of a lens object, and the post-lenticular space 8. Light strands 3 can be visualized as they traverse the lens field, mapping the optical effects of the lens object throughout the field.

Visualization chamber 1 creates a space to visualize light pathways. It can be open in air which is opaque due to micro particles. This may include carbon or water vapor. It may be enclosed and filled with liquid. The liquid may be of variable compositions, densities, and colors. Fluorescence of various wavelengths may be used to highlight light strands. Transparent solids of various compositions, densities, and colors may be used.

Lens object 4 is within the chamber. It may be fixed or mobile in all directions. It may have access from outside the chamber to manipulate or replace it. It may be fixated by wire and float. It may be fixated by clamp attached to floor or wall of chamber. The lens object may be of various size, shape, translucency, optical power, and multifocality.

The source 2 of light strands 3 may include a laser. Another source may include diffraction of light on a slit. Light strands or beams can be of variable patterns, shapes, densities, and size. They may also consist of different electromagnetic wavelengths such as infrared and ultraviolet. To assess optical properties, these light strands can be applied at each point of a lens object. This can be done at individual points with a single light strand or in a stratified array to assess multiple points. The pattern of stratification can vary. Light strands can be linear, angular, or other configuration. It can consist of a square, circular, or varied pattern. It can involve the entire object or one point of the object. It can involve multiple strands simultaneously or a single strand. Analogous to a wind tunnel that uses opaque air to observe effects on objects, these strands of light can create a light tunnel that visually observes lens effects as light traverses through lens objects. The light strands can be applied to total lens fields, and their entire pathways visually monitored.

Using fine, linear light strands, optical properties of each point of a lens can be optically analyzed along its entire path. Combining each point allows visualization of the total lens optical effects and pathways. The total field includes pre-lenticular, intra-lenticular, and post-lenticular space to the focal point and beyond. This reveals optical effects including refraction, reflection, diffraction, scatter, and loss of light. Visualization can be 2 dimensional, 3 dimensional if viewed from various angles, or 4 dimensional if viewed while making real time changes in the apparatus. When combined, it reveals optical characteristics of a lens in a total lens field.

An image can be obtained of the entire visualization chamber 1 with an external camera to reveal light propagation through the entire lens field. Images may be obtained at various angles to give 3D views. Various magnifications, exposure settings, and optical settings can be used to modify visualization.

A photodetector 5 may be placed in the pre or post lenticular space. It may be mobile in all directions to image strands at various distances from the lens. The process can be reversed to see effects of the lens from light in the opposite direction. The images can be of a single strand or multiple strands simultaneously. The data points of single or multiple strands interacting with a photodetector at a point in time create frames. Frames can be combined and re-constructed, creating 3D visualization and modeling. This creates a 3D visual light tunnel that can be explored in the x, y, and z axis. Any of these settings or the lens object can be modified and the changes in the light tunnel visualized in real time creating 4D visualization. This multidimensional capability provides more robust data on lens properties.

This data may be applied to validate theoretical models and computer simulations. These detailed images permit an in-depth comparison between theoretical lens designs and actual effects. Ray tracing, field tracing, and geometrical optics, relying on modeling and algorithms, have been successful in demonstrating lens effects, but they remain simulations. With an optical tunnel methodology, visually evident lens effects, not abstract concepts, are appreciated and can be compared with theoretical models.

Aberrant light may be detected pre and post lens and rectified with design changes. Stray light strands are the probable etiology of unwanted reflections and dysphotopsias noticed by patients after intraocular placement. Positive dysphotopsias can be caused by aberrant strands of light generated from a lens design. Isolated stray strands of light produce starbursts. Greater number of diffuse strands produce glare. Strands also coalesce into rings causing halos. Negative dysphotopsias can be due to blocked strands of light resulting from a particular lens edge or design. Anterior scatter away from the lens can reveal how some light is lost. Unintended optical paths of stray light and optical falloff can be observed. These visualizations can be quantified to measure the efficiency of the lens, energy loss, and lowered contrast sensitivity. Spectacle lenses and contacts lenses are also known to produce glare and halos. Multifocal intraocular lenses and multifocal contacts frequently cause visual disturbance and adaptation difficulty. Visually observing their complete light paths can assist in pinpointing aberrant lens behavior that exacerbate visual problems. This will aid in developing modifications to mitigate them. Determination of optimal lens designs can be the end result.

As this technique can visualize the total lens path, it can also be applied to a complete eye model. The visualization chamber can be modified to incorporate an artificial cornea, variable pupil aperture, lens, and curved retina to monitor where each strand of light settles, whether intended or unintended. This is also applicable to IOL power formulas to optimize precision.

Using stratified light strands, this optical tunnel modality, akin to a wind tunnel, is a novel development in the field of optics. As wind tunnels have become an integral part of aerodynamic analysis, light tunnels, directly visualizing light pathways, can play an important role in optico-dynamic analysis of lens objects. The Light Strand Optical Tunnel can validate the theoretical properties of lenses, help in optimizing optical designs, and contribute towards developing new structures and configurations that improve the science of optics.

Different sizes, styles, and shapes of the various components can be used for different functions. The above can also be modified and reconfigured to create the same or similar functions.

While exemplary embodiments have been described and illustrated, these should not be construed as limitations on the scope of what is claimed or on what may be claimed. Various modifications and enhancements can be made without departing from the spirit and scope of the invention.

The invention claimed is:

1. An apparatus for direct visualization of lens optical properties along an entire lens field comprising a visualization chamber.

2. An apparatus for direct visualization of lens optical properties along an entire lens field as set forth in claim 1, further comprising a light source, a lens object, and a photodetector.

3. A method of utilizing the apparatus as set forth in claim 1 to assess the total lens field comprising pre-lenticular space, intra-lenticular space, and post-lenticular space as linear strands of light propagate through the field.

4. A method of utilizing the apparatus as set forth in claim 2 to create discrete photon packets of light strands to assess optical properties of a lens field wherein the strands may be of varied size, shape, intensity, wavelength, and configuration including linear, angled, single, multiple, or stratified.

5. A method of utilizing the apparatus as set forth in claim 2 to visualize light strand propagation through a total lens field employing varied media and photo-imaging techniques and settings.

6. A method of utilizing the apparatus as set forth in claim 2 to create an optical tunnel wherein light stands are directly visualized in two or three dimensions dependent on the viewing angle as they propagate along the total lens field.

7. A method of utilizing the apparatus as set forth in claim 2 to visualize light strand propagation dynamically through a lens field in 4 dimensions through active monitoring as real time manipulations are made.

8. A method of utilizing the apparatus as set forth in claim 2 in a mobile configuration to record light strands in frames along different points of the lens field.

9. A method of utilizing the apparatus as set forth in claim 2 to optically analyze recorded frames and digitally reconstruct the data into a 3 dimensional modality.

10. A method of utilizing the apparatus as set forth in claim 2 to detect aberrant light movement.

11. A method of utilizing the apparatus as set forth in claim 2 to visualize total lens field optical properties and apply them to the development of optimal lens design and lens calculations.

12. A method of utilizing the apparatus as set forth in claim 2 to assess objects or conditions that do not transmit or variably transmit light.
